(19) United States
(12) Patent Application Publication
(10) Pub. No.: US 2024/0342657 A1
(43) Pub. Date: Oct. 17, 2024

(54) WATER TREATMENT SYSTEM AND WATER TREATMENT METHOD

(71) Applicant: ORGANO CORPORATION, Tokyo (JP)

(72) Inventors: Keisuke SASAKI, Tokyo (JP); Yuki NAKAMURA, Tokyo (JP); Ryosuke TERASHI, Tokyo (JP); Fumio SUDO, Tokyo (JP)

(73) Assignee: ORGANO CORPORATION, Tokyo (JP)

(21) Appl. No.: 18/703,459

(22) PCT Filed: Sep. 9, 2022
(86) PCT No.: PCT/JP2022/033856

§ 371 Date: Apr. 22, 2024

(30) Foreign Application Priority Data
Oct. 25, 2021 (JP) 2021-173932
Oct. 25, 2021 (JP) 2021-173933

(51) Int. Cl. B01D 61/58; B01D 61/02; B01D 61/48; C02F 1/44; C02F 1/469; C02F 101/10

(52) U.S. Cl. CPC B01D 61/58; C02F 1/441; C02F 1/4695; B01D 61/025; B01D 61/48; B01D 2313/221; C02F 2101/108; C02F 2209/02; C02F 2301/046; C02F 2303/10

(57) ABSTRACT

A water treatment system includes a reverse osmosis membrane device, an electrodeionization device that is located downstream of the reverse osmosis membrane device, a first heat exchanger that is located upstream of the reverse osmosis membrane device and that adjusts the temperature of the water supplied to the reverse osmosis membrane device according to the temperature of raw water supplied to the water treatment system, and a second heat exchanger that is located between the reverse osmosis membrane device and the electrodeionization device and that cools the water supplied to the electrodeionization device. One of the first heat exchanger and the second heat exchanger is an internal heat exchanger that exchanges heat inside the water treatment system, and the other is an external heat exchanger that exchanges heat with the outside of the water treatment system.

### TECHNICAL FIELD

This application is based on Japanese patent applications 2021-173932 and 2021-173933 filed on Oct. 25, 2021, and claims priority based on those applications, which are incorporated herein by reference in their entirety.

The present invention relates to a water treatment system and a water treatment method.

### BACKGROUND ART

In water treatment systems, water treatment devices such as reverse osmosis membrane devices and electrodeionization device are arranged in series. Each water treatment device has a suitable water temperature condition, and the temperature of the water supplied to each water treatment device is adjusted to an appropriate temperature by a heat exchanger. Japanese Utility Model Laid-open No. 49-983946 discloses that after water that has been heated in a heat exchanger is supplied to a reverse osmosis membrane device, exhaust heat is recovered from the treated water of the reverse osmosis membrane device, and this exhaust heat is used to preheat water that is to be supplied to the reverse osmosis membrane device. According to this water treatment system, thermal energy for heating water to be treated to a suitable water temperature condition for a reverse osmosis membrane device can be saved, and the thermal efficiency of the water treatment system can be increased.

### SUMMARY OF INVENTION

The temperature of raw water varies depending on the environment (such as a high temperature region or a low temperature region) of the installation of the water treatment system and also varies depending on the type of water (such as groundwater, city water, etc.) used to supply the raw water. In the water treatment system described in Japanese Utility Model Application Laid-open No. 49-983946, the exhaust heat of a reverse osmosis membrane device is used to preheat the water to be supplied to the reverse osmosis membrane device, but a reverse osmosis membrane device is not the only water treatment device that requires temperature control. For example, the preferred water temperature for an electrodeionization device is different from the preferred water temperature for a reverse osmosis membrane device. Therefore, even if the thermal efficiency of each water treatment device is optimized, it is difficult to improve the thermal efficiency of the entire water treatment system.

An object of the present invention is to provide a water treatment system that is equipped with a reverse osmosis membrane device and an electrodeionization device and that is capable of improving the thermal efficiency of the entire system for various raw water temperatures.

The water treatment system of the present invention comprises at least one reverse osmosis membrane device; at least one electrodeionization device that is located downstream of the at least one reverse osmosis membrane device; a first heat exchanger that is located upstream of the at least one reverse osmosis membrane device and that adjusts the temperature of the water supplied to the at least one reverse osmosis membrane device according to the temperature of the raw water supplied to the water treatment system; and a second heat exchanger that is located between the at least one reverse osmosis membrane device and the at least one electrodeionization device and that cools the water supplied to the electrodeionization device. One of the first heat exchanger and the second heat exchanger is an internal heat exchanger that exchanges heat inside the water treatment system, and the other is an external heat exchanger that exchanges heat with the outside of the water treatment system.

According to the present invention, it is possible to provide a water treatment system that includes a reverse osmosis membrane device and an electric regeneration type deionization device and that is capable of improving the thermal efficiency of the entire system for various raw water temperatures.

The above-mentioned and other objects, features, and advantages of the present application will become apparent from the following detailed description taken in conjunction with the accompanying drawings that illustrate the present application.

### BRIEF DESCRIPTION OF DRAWINGS

FIG. 1A is a schematic diagram showing the configuration of a water treatment system according to a first embodiment.

FIG. 1B is a schematic diagram showing the configuration of a water treatment system according to a modification of the first embodiment.

FIG. 1C is a schematic diagram showing the configuration of a water treatment system according to another modification of the first embodiment.

FIG. 1D is a schematic diagram showing the configuration of a water treatment system according to yet another modification of the first embodiment.

FIG. 2 is a diagram showing the relationship between water temperature and silica removal efficiency in a reverse osmosis membrane device.

FIG. 3 is a diagram showing the relationship between water temperature and silica removal efficiency in an electrodeionization device.

FIG. 4A is a diagram showing the relationship between water temperature and boron removal efficiency in an electrodeionization device.

FIG. 4B is a diagram showing the relationship between water temperature and boron removal efficiency in an electrodeionization device.

FIG. 5A is a schematic diagram showing the configuration of a water treatment system according to a second embodiment.

FIG. 5B is a schematic diagram showing the configuration of a water treatment system according to a modification of the second embodiment.

FIG. 5C is a schematic diagram showing the configuration of a water treatment system according to another modification of the second embodiment.

FIG. 5D is a schematic diagram showing the configuration of a water treatment system according to yet another modification of the second embodiment.

FIG. 5E is a schematic diagram showing the configuration of a water treatment system according to yet another modification of the second embodiment.

FIG. 6A is a schematic diagram showing the configuration of a water treatment system according to a third embodiment.

FIG. 6B is a schematic diagram showing the configuration of a water treatment system according to a modification of the third embodiment.

FIG. 6C is a schematic diagram showing the configuration of a water treatment system according to another modification of the third embodiment.

FIG. 6D is a schematic diagram showing the configuration of a water treatment system according to yet another modification of the third embodiment.

FIG. 7A is a schematic diagram showing the configuration of a water treatment system according to a fourth embodiment.

FIG. 7B is a schematic diagram showing the configuration of a water treatment system according to a modification of the fourth embodiment.

FIG. 8 is a diagram showing the relationship between current magnification and boron removal efficiency of an electrodeionization device.

FIG. 9A is a schematic diagram showing the configuration of a water treatment system according to a fifth embodiment.

FIG. 9B is a schematic diagram showing the configuration of a water treatment system according to a modification of the fifth embodiment.

FIG. 10A is a schematic diagram showing the configuration of a water treatment system according to a sixth embodiment.

FIG. 10B is a schematic diagram showing the configuration of a water treatment system according to a modification of the sixth embodiment.

FIG. 11 is a schematic diagram showing the configuration of a water treatment system according to a seventh embodiment.

FIG. 12 is a schematic diagram showing the configuration of a water treatment system according to an eighth embodiment.

FIG. 13 is a schematic diagram showing the configuration of a water treatment system according to a ninth embodiment.

### DESCRIPTION OF EMBODIMENTS

Hereinafter, embodiments of the present invention will be described with reference to the drawings. Water treatment systems 101, 201, 301, 401, 501, 601, 701, 801, and 901 of each embodiment have primary system S1 and secondary system S2. Secondary system S2 is located downstream of primary system S1 and upstream of point of use 2. Primary system S1 produces pure water from raw water, and secondary system S2 produces ultrapure water from pure water. Secondary system S2 is also called a subsystem. Secondary system S2 comprises various water treatment devices 21 to 25 for further treating the treated water of electrodeionization device 18 of primary system S1. The ultrapure water (treated water of the water treatment device) produced in secondary system S2 is sent to point of use 2. Of the ultrapure water produced in secondary system S2, the ultrapure water that is not used at point of use 2 is returned to the upstream side of water treatment devices 21-25 through second recirculation line L3 connected to main pipe L2 of secondary system S2. Pure water or ultrapure water is constantly circulating within the secondary system S2. Secondary system S2 is an area in which pure water or ultrapure water circulates, and includes main pipe L2 and second recirculation line L3, as well as all the equipment installed on main pipe L2 and second recirculation line L3. Point of use 2 is connected to water treatment systems 101, 201, 301, 401, 501, 601, 701, 801, and 901 by line L4 that branches from main pipe L2.

### Summary of the First to Third Embodiments

As will be described in detail in each embodiment, water treatment systems 101, 201, and 301 each comprise first heat exchanger 31 that is located upstream of reverse osmosis membrane device 14 and that, according to the temperature of raw water supplied to the water treatment system, adjusts the temperature of water to be supplied to reverse osmosis membrane device 14; and second heat exchanger 32 that is located between reverse osmosis membrane device 14 and electrodeionization device 18 and that cools the water to be supplied to electrodeionization device 18. According to these embodiments, one of first heat exchanger 31 and second heat exchanger 32 operates as an internal heat exchanger that exchanges heat inside the water treatment system, and the other operates as an external heat exchanger that exchanges heat with the outside of the water treatment system. The raw water supplied to the water treatment system contains silica and boron, the silica concentration of the water treated by reverse osmosis membrane device 14 being 100 ppb or less and the boron concentration being 50 ppb or less. The silica concentration of the water treated by electrodeionization device 18 is 100 ppt or less and the boron concentration is 50 ppt or less.

### First Embodiment

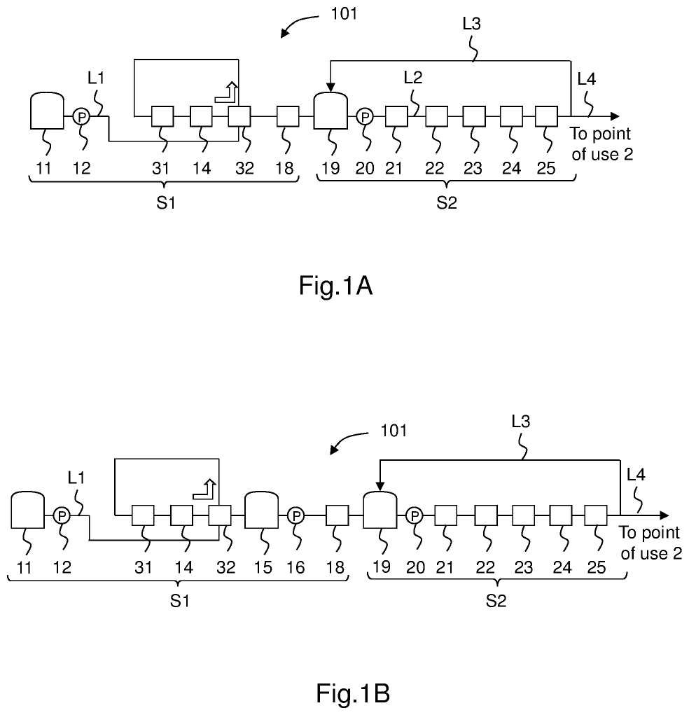

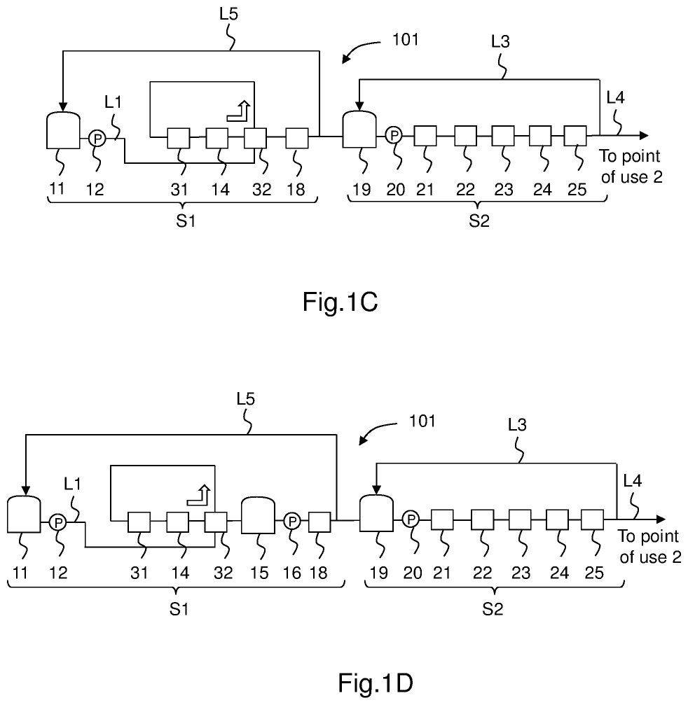

FIG. 1A shows a schematic configuration of a water treatment system 101 according to the first embodiment of the present invention. In this embodiment, the temperature of the raw water supplied to water treatment system 101 is lower than a predetermined temperature range (for example, 15° C.). As mentioned above, water treatment system 101 is divided into primary system S1 and secondary system S2. Primary system S1 will be explained first, followed by an explanation of secondary system S2. Note that the devices constituting primary system S1 and secondary system S2 are not limited to those described below, and other components such as tanks and pumps may be installed as necessary.

Primary system S1 comprises raw water tank 11, raw water pump 12, second heat exchanger 32, first heat exchanger 31, at least one reverse osmosis membrane device 14, and at least one electrodeionization (EDI) device 18, these devices being arranged in series from upstream to downstream in the direction in which the water to be treated flows along main pipe L1 through which the water to be treated flows. The water being treated passes through second heat exchanger 32 again between reverse osmosis membrane device 14 and electrodeionization device 18. At least one reverse osmosis membrane device 14 includes both a single-stage reverse osmosis membrane device and a multiple-stage reverse osmosis membrane device connected in series and is simply referred to as reverse osmosis membrane device 14 in the following description. At least one electrodeionization device 18 includes both a single-stage electrodeionization device and a multiple-stage electrodeionization device connected in series and is simply referred to as electrodeionization device 18 in the following description. Water quality can be further improved by arranging at least one of reverse osmosis membrane device 14 and electrodeionization device 18 in series in multiple stages. Although not shown, at least one of a membrane deaerator for removing carbonic acid and dissolved oxygen, an ion exchange resin device, an ultraviolet irradiation device, and a boron selective resin device may be provided between reverse osmosis membrane device 14 and electrodeionization device 18.

Raw water tank 11 stores both raw water produced in a pretreatment system (not shown) provided upstream of primary system S1 and water (pure water, ultrapure water, concentrated water, and electrode water from electrodeionization device 18, etc.) that is generated in subsequent equipment and then recovered. Raw water pump 12 extracts the raw water stored in raw water tank 11 and supplies the raw water to second heat exchanger 32 and subsequently to first heat exchanger 31.

First heat exchanger 31 operates as a heater that heats the water to be supplied to reverse osmosis membrane device 14 to a predetermined temperature. First heat exchanger 31 is an external heat exchanger that is located upstream of reverse osmosis membrane device 14 and that exchanges heat with the outside of water treatment system 101. First heat exchanger 31 heats the water supplied to reverse osmosis membrane device 14. If the temperature of the water supplied to reverse osmosis membrane device 14 is too low, the viscosity of the supplied water increases, making it difficult for the supplied water to permeate through reverse osmosis membrane device 14. This may increase the pressure loss of reverse osmosis membrane device 14 and increase the power cost and pump capacity of raw water pump 12. Further, when the flow rate per element of reverse osmosis membrane device 14 is reduced in order to reduce pressure loss, the number of elements increases. On the other hand, if the temperature of the water supplied to reverse osmosis membrane device 14 is too high, problems such as elution of the membrane material, precipitation of dissolved components in the supplied water, and generation of biological slime are likely to occur. First heat exchanger 31 adjusts the temperature of the water supplied to reverse osmosis membrane device 14 to 15° C. or higher and 40° C. or lower, and preferably to about 20° C. to 30° C. Reverse osmosis membrane device 14 removes fine particles, ionic components, silica, etc. contained in the water to be treated.

Second heat exchanger 32 is provided between reverse osmosis membrane device 14 and electrodeionization device 18. Second heat exchanger 32 cools the treated water of reverse osmosis membrane device 14 or the water to be supplied to electrodeionization device 18 to a predetermined temperature. Second heat exchanger 32 is an internal heat exchanger that exchanges heat inside water treatment system 101. Arrows indicate the direction of heat transfer. As will be described later, when the temperature of water supplied to electrodeionization device 18 is low, the boron removal efficiency improves. The predetermined temperature is from about 10° C. to 30° C., and preferably from about 15° C. to 24° C. Electrodeionization device 18 removes ionic components contained in the water being treated. Electrodeionization device 18 also removes silica and boron contained in the water being treated. The treated water of electrodeionization device 18 is stored in sub-tank 19 of secondary system S2.

As mentioned above, the low temperature water supplied to reverse osmosis membrane device 14 is heated in second heat exchanger 32 before being heated in first heat exchanger 31. Therefore, the thermal energy required by first heat exchanger 31 is reduced. On the other hand, thermal energy of the high temperature treated water of reverse osmosis membrane device 14 is transferred to the low temperature water supplied to reverse osmosis membrane device 14, and the water treated by reverse osmosis membrane device 14 is thus is cooled to a temperature suitable for water to be supplied to electrodeionization device 18. Since thermal energy is transferred from water that does not require thermal energy to water that requires thermal energy by heat exchange, the energy usage efficiency of the entire primary system S1 is improved.

Subsystem S2 is located between electrodeionization device 18 and point of use 2. Secondary system S2 comprises sub-tank (pure water tank) 19, pure water pump 20, heat exchanger 21, ultraviolet irradiation device 22, ion exchange device 23, membrane deaerator 24, and ultrafiltration membrane device 25, and these devices are arranged in series from upstream to downstream in the direction of flow of the water being treated along main pipe L2 through which the water being treated flows. Pure water pump 20 extracts the pure water stored in sub-tank 19 and supplies the pure water to heat exchanger 21. Generally, the required water temperature (for example, from about 24° C. to 26° C.) of the ultrapure water supplied to point of use 2 is determined. Heat exchanger 21 is provided to adjust the temperature of the ultrapure water supplied to point of use 2. When second heat exchanger 32 cools the water supplied to electrodeionization device 18, the treated water of electrodeionization device 18 is usually heated, and heat exchanger 21 can therefore be a heater. However, if the water temperature of the water being treated increases due to heat input from electrodeionization device 18, exhaust heat from pure water pump 20, or an increase in the amount of circulating water flowing through second recirculation line L3, heat exchanger 21 may also cool the water being treated. Therefore, when there is a possibility of cooling the water being treated, it is preferable that heat exchanger 21 be capable of both cooling and heating. Ultraviolet irradiation device 22 irradiates the water being treated with ultraviolet rays to decompose organic substances contained in the water being treated. Ion exchange device 23 removes decomposition products generated by ultraviolet irradiation device 22. Membrane deaerator 24 removes dissolved oxygen contained in the water being treated. Ultrafiltration membrane device 25 removes fine particles contained in the water being treated. Ultrapure water produced in this way is sent to point of use 2, and the water not used at point of use 2 is returned to sub-tank 19 through second recirculation line L3.

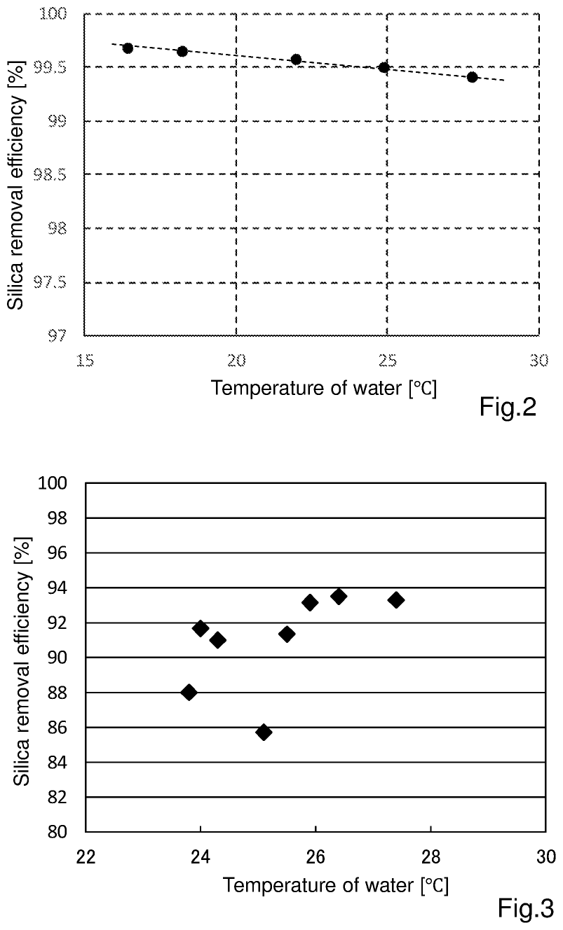

FIG. 2 shows an example of measurement of the relationship between water temperature and silica removal efficiency in reverse osmosis membrane device 14. Although the silica removal efficiency decreased as the water temperature increased, no significant decrease in the removal efficiency was observed, and the influence of temperature is therefore limited. On the other hand, although not shown, the boron removal efficiency of reverse osmosis membrane device 14 was not very high, and from the viewpoint of boron removal efficiency, the temperature of the water supplied to reverse osmosis membrane device 14 is not particularly limited. FIG. 3 shows an example of measurement of the relationship between water temperature and silica removal efficiency in electrodeionization device 18. As the water temperature increased, the silica removal efficiency also increased, and as the water temperature decreased, the silica removal efficiency also decreased.

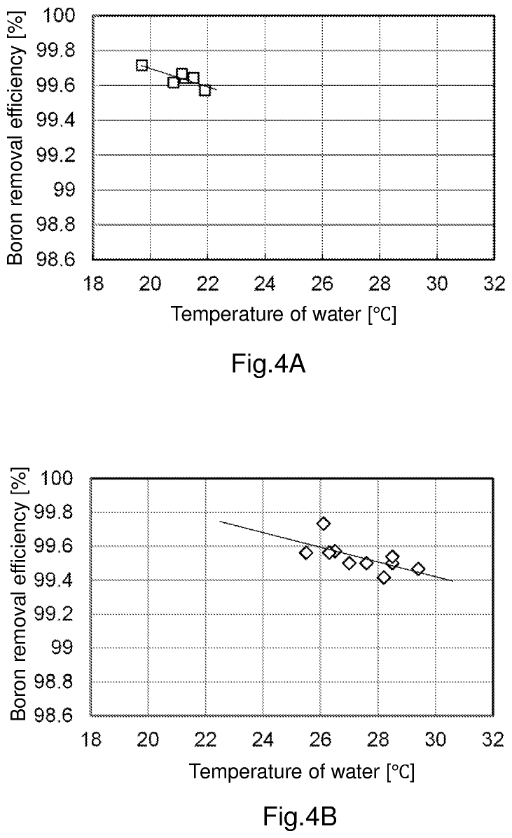

FIGS. 4A and 4B show examples of measurements of the relationship between water temperature and boron removal efficiency in electrodeionization device 18. Since different electrodeionization devices 18 were used depending on the water temperature range, the results are shown separately in FIGS. 4A and 4B for convenience. The water supplied to electrodeionization device 18 contained boron (5 to 20 ppb), silica (5 to 10 ppb), and carbonic acid (1 ppm). Here, the carbonic acid concentration was a concentration of the total amount of carbonic acid components such as H₂CO₃, HCO₃⁻, CO₃²⁻, etc., expressed as a CO₂ equivalent concentration. A lower temperature of the water supplied to electrodeionization device 18 improved the boron removal efficiency. For example, assuming that the boron concentration in the supplied water is 10 ppb, the boron concentration in the water treated by electrodeionization device 18 was 60 ppt (removal efficiency of 99.4%), and the target value was 50 ppt. In this case, it is expected that lowering the water temperature by about 1° C. will improve the removal efficiency by about 0.05%, and lowering the water temperature by about 2° C. should achieve the target value of 50 ppt (removal efficiency of 99.5%).

As described above, since only electrodeionization device 18 can remove boron with high efficiency, the temperature of the water supplied to electrodeionization device 18 is set to a temperature suitable for removing boron. As a result, removal of silica by electrodeionization device 18 becomes difficult and it is therefore desirable to remove as much silica as possible by reverse osmosis membrane device 14. However, as described above, the temperature of the water supplied to reverse osmosis membrane device 14 does not significantly affect the silica removal efficiency. On the other hand, if the temperature of the water treated by reverse osmosis membrane device 14 becomes too high, second heat exchanger 32 may not be able to sufficiently lower the temperature of the water supplied to electrodeionization device 18. Based on these factors, the temperature of the water supplied to reverse osmosis membrane device 14 is set to from 15° C. to 40° C., and the temperature of the water supplied to electrodeionization device 18 is set to from 10° C. to 30° C.

### (Modifications of the First Embodiment)

Examples of modifications of the first embodiment are shown in FIGS. 1B to 1D. In the modification shown in FIG. 1B, RO treated water tank 15 and RO treated water transfer pump 16 are provided between second heat exchanger 32 and electrodeionization device 18. RO treated water tank 15 stores the treated water of reverse osmosis membrane device 14, and RO treated water transfer pump 16 supplies the water stored in RO treated water tank 15 to electrodeionization device 18. Since RO treated water tank 15 and RO treated water transfer pump 16 are provided upstream of electrodeionization device 18, electrodeionization device 18 and reverse osmosis membrane device 14 can be operated separately. Furthermore, since RO treated water tank 15 functions as a buffer tank, primary system S1 is less susceptible to changes in the amount of ultrapure water used at point of use 2.

In the modification shown in FIG. 1C, first recirculation line L5 is provided for returning at least a portion of the treated water from electrodeionization device 18 to upstream of reverse osmosis membrane device 14 (in this modification, to raw water tank 11). Subsystem S2 is located between the branch of first recirculation line L5 and point of use 2. When sub-tank 19 downstream of primary system S1 becomes full of water, the operation of primary system S1 can be continued by circulating water through first recirculation line L5. If the operation of primary system S1 is stopped, there is a possibility that the water quality will deteriorate in the areas where water is stagnant. By continuously operating primary system S1, water stagnation can be reduced and high water quality can be stably maintained. When water can be sent to sub-tank 19 downstream of primary system S1, a valve (not shown) of first recirculation line L5 is closed, and the entire amount of treated water from electrodeionization device 18 is sent to sub-tank 19. Alternatively, by reducing the degree of openness of the valve of first recirculation line L5, a portion of the treated water from electrodeionization device 18 may be sent to sub-tank 19 and the rest returned upstream of reverse osmosis membrane device 14.

The modification shown in FIG. 1D is a combination of the modifications shown in FIG. 1B and FIG. 1C. In this case, first recirculation line L5 may be connected to RO treated water tank 15.

### Second Embodiment

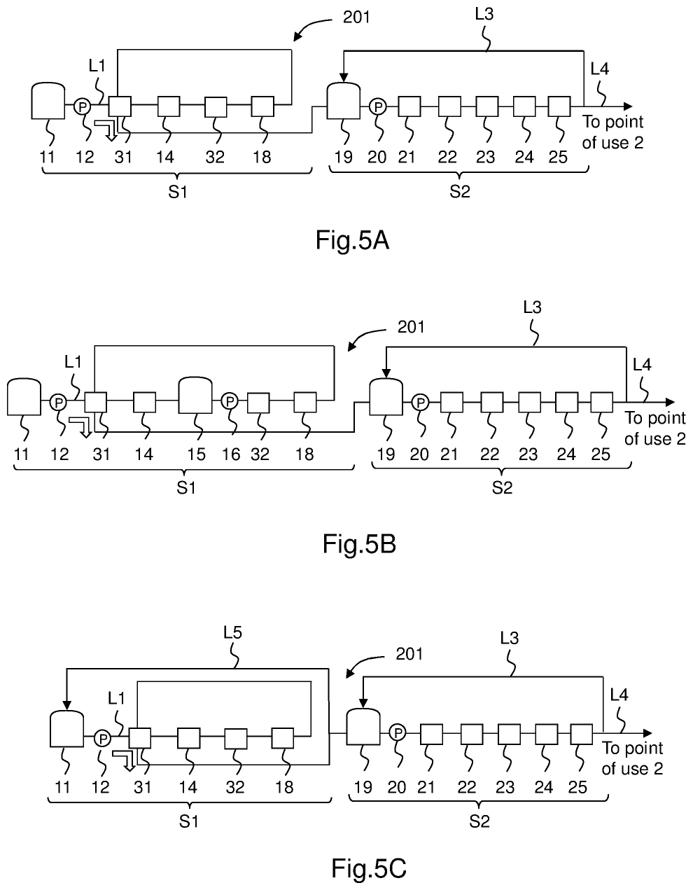

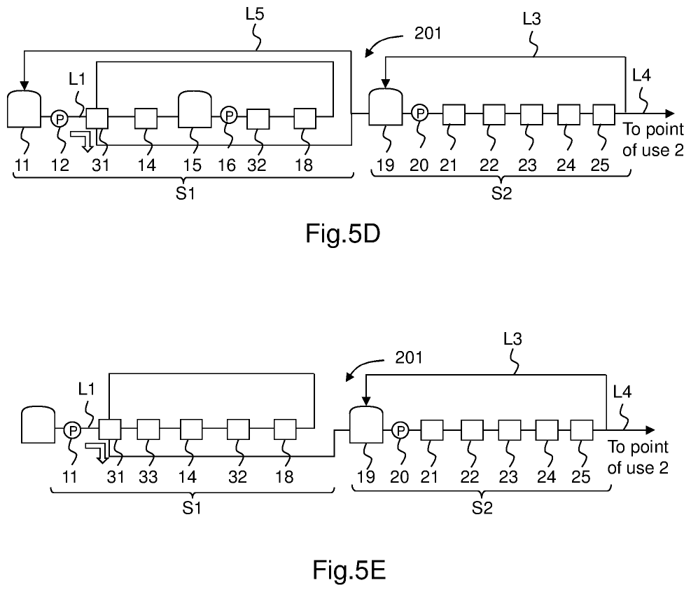

FIG. 5A shows a schematic configuration of a water treatment system 201 according to the second embodiment of the present invention. The following explanation will focus on differences from the first embodiment. Explanation of configuration and effects that are the same as those of the first embodiment is here omitted. In this embodiment, the temperature of the raw water supplied to water treatment system 201 is higher than a predetermined temperature range (for example, 40° C.). Unlike the first embodiment, second heat exchanger 32 cannot utilize the cooling source (the low temperature of the raw water) inside water treatment system 201 for cooling. For this reason, second heat exchanger 32 is an external heat exchanger that operates as a cooler.

Unlike the first embodiment, first heat exchanger 31 operates as a cooler. The raw water is cooled by first heat exchanger 31 to a temperature suitable for supplying water to reverse osmosis membrane device 14. The temperature of the water treated by electrodeionization device 18 is lower than the temperature of the raw water supplied to water treatment system 201. Therefore, first heat exchanger 31 is an internal heat exchanger that exchanges heat inside water treatment system 201. With such a configuration, the low temperature treated water of electrodeionization device 18 can be used to cool the water supplied to reverse osmosis membrane device 14. Furthermore, when heat exchanger 21 of secondary system S2 is used as a heater, the water supplied to heat exchanger 21 is preheated by first heat exchanger 31, so the load on heat exchanger 21 is reduced. Therefore, the energy usage efficiency of entire water treatment system 201 is improved.

### (Modifications of Second Embodiment)

Modifications of the second embodiment are shown in FIGS. 5B to 5E. In the modification shown in FIG. 5B, RO treated water tank 15 and RO treated water transfer pump 16 are provided between reverse osmosis membrane device 14 and second heat exchanger 32. RO treated water tank 15 stores the treated water of reverse osmosis membrane device 14, and RO treated water transfer pump 16 supplies the water stored in RO treated water tank 15 to electrodeionization device 18.

In the modification shown in FIG. 5C, first recirculation line L5 is provided for returning at least a portion of the treated water from electrodeionization device 18 to upstream of reverse osmosis membrane device 14 (in this modification, to raw water tank 11). Subsystem S2 is located between the branch of first recirculation line L5 and point of use 2.

The modification shown in FIG. 5D is a combination of the modifications shown in FIG. 5B and FIG. 1C. In this case, first recirculation line L5 may be connected to RO treated water tank 15. The effects of the modifications shown in FIGS. 5B to 5D are similar to those of the modifications shown in FIGS. 1B to 1D.

In the modification shown in FIG. 5E, third heat exchanger 33 is provided between first heat exchanger 31 and reverse osmosis membrane device 14 to cool the water supplied to reverse osmosis membrane device 14. Third heat exchanger 33 is an external heat exchanger that exchanges heat with the outside of water treatment system 201 and may be provided when the raw water temperature is high and the temperature of water supplied to the reverse osmosis membrane device 14 cannot be lowered sufficiently by first heat exchanger 31 alone.

### Third Embodiment

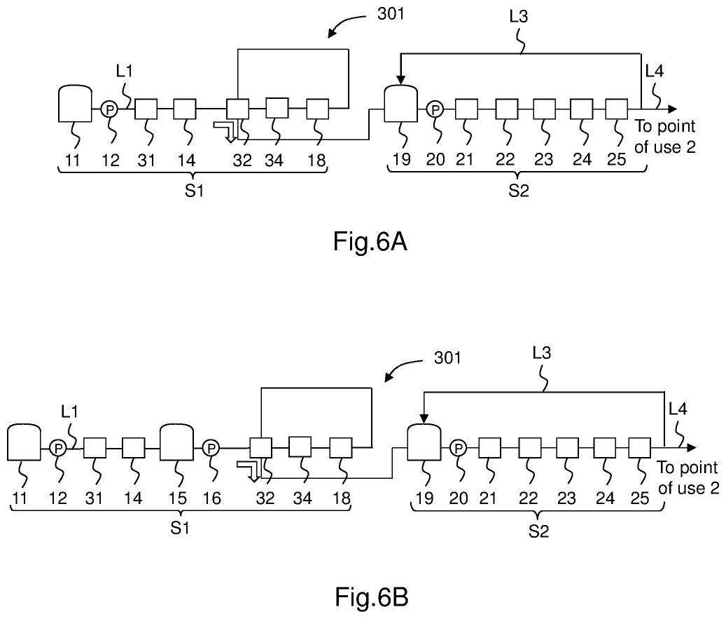

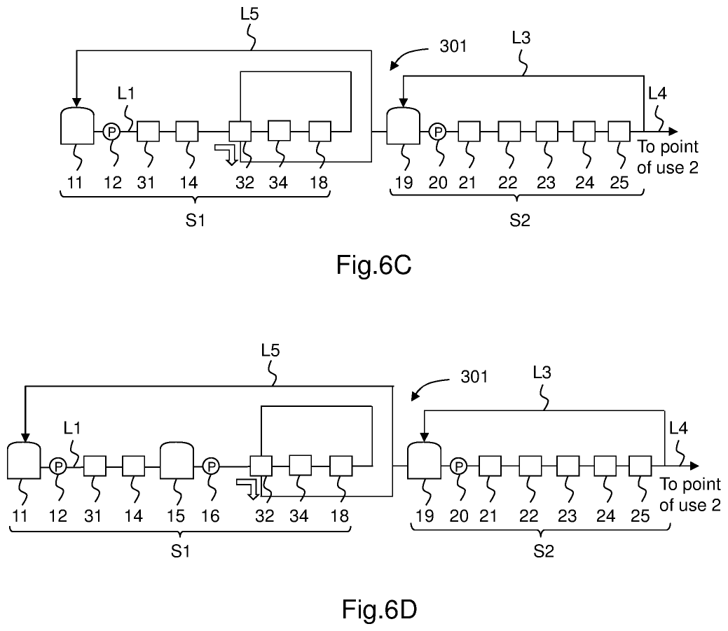

FIG. 6A shows a schematic configuration of water treatment system 301 according to the third embodiment of the present invention. In this embodiment, the temperature of the raw water supplied to water treatment system 301 is generally within a predetermined temperature range (for example, from 15° C. to 40° C.). However, the temperature of the water supplied to reverse osmosis membrane device 14 may vary within the predetermined temperature range or may vary within or outside the predetermined temperature. Such a phenomenon may occur due to fluctuations in raw water temperature but may also be caused by the operation of primary system S1 or secondary system S2. The raw water is stored in raw water tank 11 after rough temperature adjustment, but the temperature of the raw water may also fluctuate when raw water tank 11 receives water (pure water, ultrapure water, or concentrated water or electrode water from, for example, electrodeionization device 18) that is recovered after being generated in downstream equipment. In this embodiment, the temperature of the raw water supplied to water treatment system 301 is within a relatively preferable range, but it may be desirable to adjust the temperature of the water supplied to reverse osmosis membrane device 14 to a more preferable range.

For this reason, first heat exchanger 31 is an external heat exchanger (temperature controller) that operates as a heater or a cooler. Second heat exchanger 32 operates as an internal heat exchanger to utilize the treated water of electrodeionization device 18 for cooling the water supplied to electrodeionization device 18. On the other hand, since second heat exchanger 32 alone may not be able to cool the water supplied to electrodeionization device 18 to an appropriate temperature, fourth heat exchanger 34 that cools the water supplied to electrodeionization device 18 is further provided. Fourth heat exchanger 34 is an external heat exchanger. Fourth heat exchanger 34 is located between second heat exchanger 32 and electrodeionization device 18. The cold water supplied to electrodeionization device 18 is cooled in second heat exchanger 32 before being cooled in fourth heat exchanger 34. Therefore, the cooling energy required by fourth heat exchanger 34 is reduced.

### (Modifications of Third Embodiment)

Modifications of the third embodiment are shown in FIGS. 6B to 6D. In the modification shown in FIG. 6B, RO treated water tank 15 and RO treated water transfer pump 16 are provided between reverse osmosis membrane device 14 and second heat exchanger 32. RO treated water tank 15 stores the treated water of reverse osmosis membrane device 14, and RO treated water transfer pump 16 supplies the water stored in RO treated water tank 15 to electrodeionization device 18. In the modification shown in FIG. 6C, first recirculation line L5 is provided for returning at least a portion of the treated water from electrodeionization device 18 to upstream of reverse osmosis membrane device 14 (in this modification, to raw water tank 11). Subsystem S2 is located between the branch of first recirculation line L5 and point of use 2. The modification shown in FIG. 6D is a combination of the modifications shown in FIG. 6B and FIG. 6C. In this case, first recirculation line L5 may be connected to RO treated water tank 15. The effects of the modifications shown in FIGS. 6B to 6D are similar to those of the modifications shown in FIGS. 1B to 1D.

### Summary of the Fourth to Ninth Embodiments

In ultrapure water production equipment, several water treatment devices such as an electrodeionization devices are arranged in series. Each water treatment device has suitable water temperature conditions, and the temperature of the water supplied to each water treatment device is therefore adjusted to an appropriate temperature using a heater or a cooler. For example, Japanese Patent Laid-Open No. 2021-65843 discloses a water treatment system in which the temperature of water supplied to an electrodeionization device is adjusted to a predetermined range based on the temperature of the water treated by the electrodeionization device.

In an ultrapure water production apparatus, it is not only necessary to keep the temperature of the water supplied to each water treatment device within a predetermined range, but is also necessary to keep the water temperature at the point of use, which is the final destination of ultrapure water, within a predetermined required water temperature range. However, in order to keep the temperature of the water supplied to each water treatment device and the required water temperature at the point of use within a predetermined range, it is necessary to repeatedly heat and cool the water, and this necessity decreases energy usage efficiency in the ultrapure water production apparatus. Decrease in energy usage efficiency affects operating costs.

The fourth to ninth embodiments are directed to providing a water treatment system (an ultrapure water production apparatus) that can suppress decrease in energy usage efficiency while ensuring the quality of the ultrapure water. As in the first to third embodiments, the water treatment system of the fourth to ninth embodiments includes primary system S1 and secondary system S2. The functions of primary system S1 and secondary system S2 are similar to those in the first to third embodiments, and reference should therefore be made to the first embodiment for details.

### Fourth Embodiment

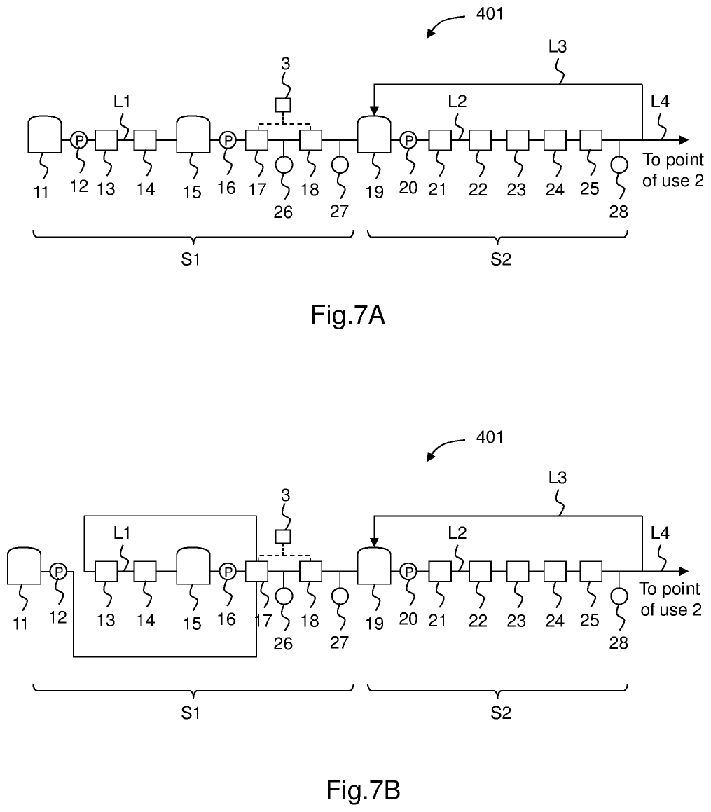

FIG. 7A shows a schematic configuration of water treatment system 401 according to the fourth embodiment of the present invention. As mentioned above, water treatment system 401 is divided into primary system S1 and secondary system S2. Explanation is first given regarding primary system S1, followed by an explanation regarding secondary system S2. However, description of configurations common to the first to third embodiments will be omitted. Each device of primary system S1 and secondary system S2 is monitored and controlled by control device 3 of ultrapure water production apparatus 1A.

Primary system S1 comprises raw water tank 11, raw water pump 12, temperature adjustment device 13, at least one reverse osmosis membrane device 14, RO treated water tank 15, RO treated water transfer pump 16, cooler 17, and at least one electrodeionization device (EDI) 18, these devices being arranged in series from upstream to downstream in the direction in which the water to be treated flows along main pipe L1 through which the water to be treated flows.

Raw water tank 11 stores both raw water produced in a pretreatment system (not shown) provided upstream of primary system S1 and water (pure water, ultrapure water, or concentrated water or electrode water from, for example, electrodeionization device 18) that is generated in subsequent equipment and then recovered. Raw water contains boron. Raw water pump 12 extracts the raw water stored in raw water tank 11 and supplies the raw water to temperature adjustment device 13. Temperature adjustment device 13 heats or cools the water to be supplied to reverse osmosis membrane device 14 to a predetermined temperature. Temperature adjustment device 13 adjusts the temperature of the water to be supplied to reverse osmosis membrane device 14 to 15° C. or higher and to 40° C. or lower and preferably from about 20° C. to 30° C. In this embodiment, temperature adjustment device 13 operates as a heater because the temperature of the water to be supplied to reverse osmosis membrane device 14 is lower than the predetermined temperature range (for example, the above-mentioned range from 15° C. to 40° C. or from 20° C. to 30° C.). However, if the temperature of the water supplied to reverse osmosis membrane device 14 fluctuates within the predetermined temperature range or fluctuates within or outside the predetermined temperature range, the temperature adjustment device may be a temperature controller having a heating and cooling function. If the temperature of the water supplied to reverse osmosis membrane device 14 fluctuates within the predetermined temperature range, temperature adjustment device 13 may be omitted. Conversely, if the temperature of the water supplied to reverse osmosis membrane device 14 is higher than the predetermined temperature range, temperature adjustment device 13 may be a cooler.

The treated water of reverse osmosis membrane device 14 is stored in RO treated water tank 15. RO treated water transfer pump 16 extracts RO treated water (filtrated water) stored in RO treated water tank 15 and supplies the RO treated water to cooler 17. Cooler 17 that is provided upstream of electrodeionization device 18 cools the water to be supplied to electrodeionization device 18 to a predetermined temperature. As mentioned above, the predetermined temperature is from about 10° C. to 30° C. and preferably from about 15° C. to 24° C. Electrodeionization device 18 removes ionic components contained in the water to be treated. Electrodeionization device 18 also removes boron contained in the water to be treated. The water treated by electrodeionization device 18 is stored in sub-tank 19 of secondary system S2. Boron concentration measuring device 27 is provided downstream of electrodeionization device 18, specifically between electrodeionization device 18 and sub-tank 19, for measuring the boron concentration of the treated water of electrodeionization device 18.

The configuration of secondary system S2 is almost the same as in the first to third embodiments. As mentioned above, when there is a possibility of cooling the water to be treated (particularly when T1−T2, which will be described later, is negative value), heat exchanger 21 is preferably capable of both cooling and heating.

Water treatment system 401 includes first thermometer 28 and second thermometer 26. First thermometer 28 is provided on the exit side of ultrafiltration membrane device 25 in secondary system S2. First thermometer 28 measures the temperature of the treated water (ultrapure water) of secondary system S2, which is to be sent from secondary system S2 to point of use 2. Second thermometer 26 is provided between cooler 17 and electrodeionization device 18 and measures the temperature of the water to be supplied to electrodeionization device 18. Electrodeionization device 18 comprises a demineralization chamber through which water being treated flows, a concentration chamber in which ionic components are concentrated to produce concentrated water, and an electrode chamber that accommodates electrodes and through which electrode water flows, no significant difference being exhibited in the temperature of the water flowing through these chambers. Therefore, in this embodiment, second thermometer 26 measures the temperature of the inlet water of the demineralization chamber, but second thermometer 26 may instead measure the temperature of the inlet water of the demineralization chamber, the inlet water or the outlet water of the concentration chamber, or the inlet water or the outlet water of the electrode chamber. That is, second thermometer 26 may measure the temperature of either water entering or exiting electrodeionization device 18.

In this embodiment, the measured value of first thermometer 28 is used to control cooler 17 that cools the water to be supplied to electrodeionization device 18. First thermometer 28 is originally installed for the purpose of water temperature management at point of use 2. For this reason, conventionally, when the measured value of first thermometer 28 was far from the required water temperature at point of use 2, heat exchanger 21 in secondary system S2 was operated to adjust the water temperature (hereinafter referred to as the “conventional example”). On the other hand, the temperature of the water supplied to electrodeionization device 18 has generally been adjusted based on a thermometer provided at the inlet of electrodeionization device 18. In other words, the water temperature of the water supplied to electrodeionization device 18 is controlled based on the water temperature measured at the inlet of electrodeionization device 18. The usual method is to use the cooler 17. In other words, the water temperature of the water supplied to electrodeionization device 18 is generally controlled by using cooler 17 based on the water temperature measured at the inlet of electrodeionization device 18. In contrast, in the present embodiment, cooler 17 is controlled based on the measured value of first thermometer 28 that is remote from electrodeionization device 18. When the measured value of first thermometer 28 for some reason rises higher than the required water temperature at point of use 2, rather than cooling the water flowing through secondary system S2 by means of heat exchanger 21, the water supplied to electrodeionization device 18 is cooled by means of cooler 17. By this method, it is possible to keep the water temperature at point of use 2 within the range of the required water temperature, and the only difference from the conventional example is the position at which the water being treated is cooled, and the thermal efficiency of water treatment system 401 as a whole therefore remains unchanged. Moreover, the boron removal efficiency of electrodeionization device 18 is improved.

Although first thermometer 28 is installed downstream of secondary system S2, that is, downstream of ultrafiltration membrane device 25 on main pipe L2, the position of first thermometer 28 on the main pipe L2 is not limited to this location. First thermometer 28 may measure the temperature of the treated water of any of the water treatment devices constituting secondary system S2. Alternatively, first thermometer 28 may be provided in second recirculation line L3. That is, first thermometer 28 measures the temperature of the water flowing at any point downstream of primary system S1, and more generally, measures the temperature of the water that has been treated by electrodeionization device 18, and that flows at any position downstream of electrodeionization device 18. Generally, since the water temperature in secondary system S2 is not the same throughout, the water being treated being heated, for example, by ultraviolet irradiation from ultraviolet irradiation device 22 or exhaust heat from pure water pump 20, the water temperature varies depending on the location within secondary system S2. The water temperature can also change due to heat exhaust from the pipes and heat input into the pipes. In this embodiment, first thermometer 28 is installed downstream of ultrafiltration membrane device 25. Therefore, the water temperature measured by first thermometer 28 almost matches the water temperature at point of use 2, but there are cases in which the distance from first thermometer 28 to point of use 2 is long and the temperature difference between the two cannot be ignored. However, such temperature changes and temperature differences can be predicted or measured in advance, and the water temperature at the installation position of first thermometer 28 and the water temperature at point of use 2 will have a predetermined correspondence relationship. Therefore, it is possible to control cooler 17 using the measured value of first thermometer 28. Specifically, cooler 17 is activated when the water temperature at the installation position of first thermometer 28 exceeds the value that corresponds to the required water temperature of point of use 2. For example, if the upper limit of the required water temperature at point of use 2 is 25.5° C. and the water temperature measured by first thermometer 28 is found to be 0.5° C. lower than the water temperature at point of use 2, the water temperature at the measurement position of first thermometer 28 that corresponds to a temperature of 25.5° C. at point of use 2 is 25° C. Therefore, cooler 17 is activated when the measured value of first thermometer 28 exceeds 25° C. Note that when first thermometer 28 is installed upstream of heat exchanger 21 (for example, between pure water pump 20 and heat exchanger 21), it is desirable that the temperature increase value or temperature decrease value at heat exchanger 21 be fixed in order to establish a correspondence between the measured value of first thermometer 28 and the water temperature at point of use 2.

The operating temperature of cooler 17 is not limited to the temperature corresponding to the upper limit of the required water temperature of point of use 2. The required water temperature of point of use 2 is any temperature within the range of required water temperatures, and may be the lower limit value or the median value of the required water temperatures of point of use 2. For example, when the lower limit of the required water temperature at point of use 2 is 24.5° C., the water temperature at the measurement position of first thermometer 28 that corresponds to 24.5° C. at point of use 2 is 24° C. Therefore, by activating cooler 17 when the measured value of first thermometer 28 exceeds 24° C., the water supplied to electrodeionization device 18 can be cooled in advance before the water temperature at point of use 2 reaches the upper limit of the required water temperature at point of use 2.

As mentioned above, the boron removal efficiency improves when the temperature of the water supplied to electrodeionization device 18 is low. However, if the boron concentration is sufficiently reduced, there is no need to greatly lower the water temperature, and if the water temperature falls too much below the required water temperature at point of use 2, the heating load on heat exchanger 21 will increase. Therefore, depending on the required value of boron concentration, it is generally undesirable to lower the temperature too much before electrodeionization device 18, and cooler 17 is preferably operated so that the difference T1−T2 between the temperature T1 measured by first thermometer 28 and the temperature T2 measured by second thermometer 26 is −1 degrees or more and 5 degrees or less. T1−T2 may be a negative value as long as the measured value of first thermometer 28 is controlled within a predetermined range and the boron concentration is sufficiently reduced.

As a method for lowering the boron concentration, other than lowering the temperature of the water supplied to electrodeionization device 18, the current density of the current applied to electrodeionization device 18 may also be increased. In this embodiment, these two methods can be selectively executed. In the following explanation, the operation in which cooler 17 cools the water supplied to electrodeionization device 18 will be referred to as the first operation, and the operation in which the current applied to electrodeionization device 18 is increased will be referred to as the second operation. Control device 3 controls cooler 17 and electrodeionization device 18 to perform either one of the first operation and the second operation when the boron concentration measured by boron concentration measuring device 27 is higher than a predetermined value. If the boron concentration is not equal to or less than the predetermined value during only one of the first operation and the second operation, control device 3 controls cooler 17 and electrodeionization device 18 to perform the other of the first operation and the second operation. Which operation should be prioritized can be determined as appropriate, taking into account operating costs and the like. If the current density of the current applied to electrodeionization device 18 is too great, problems such as burning of the electrodes, electrical damage, and deterioration of the ion exchange membrane and the ion exchanger are likely to occur. Therefore, when employing the second method, the current density is preferably adjusted within a range of from 0.3 A/dm² or more to 1 A/dm² or less.

FIG. 7B shows a modification of the fourth embodiment. In this embodiment, as in the first embodiment, raw water tank 11, raw water pump 12, cooler 17, temperature adjustment device 13, at least one reverse osmosis membrane device 14, and at least one electrodeionization (EDI) device 18 are arranged in series, and the water being treated passes through cooler 17 again between reverse osmosis membrane device 14 and electrodeionization device 18. Temperature adjustment device 13 corresponds to first heat exchanger 31 of the first embodiment, and cooler 17 corresponds to second heat exchanger 32 of the first embodiment.

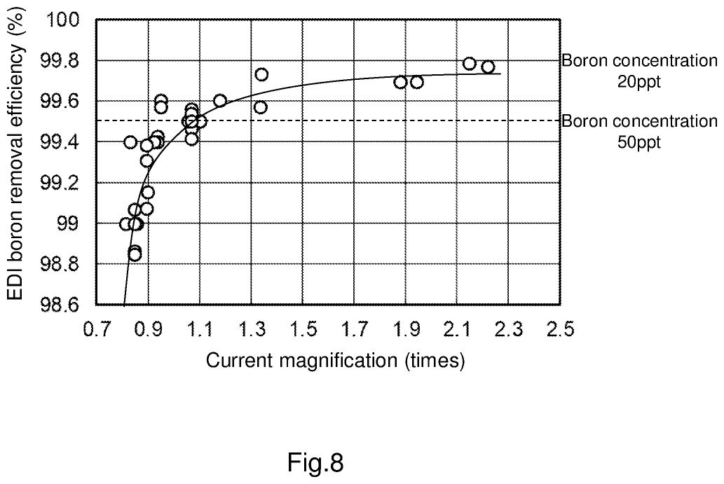

FIG. 8 shows an example of the relationship between the current magnification and boron removal efficiency of electrodeionization device 18. The current magnification is the set current magnification/set flow rate magnification, the set current magnification is the set current/standard current, and the set flow rate magnification is the treated water flow rate/standard flow rate. That is, the current magnification is the ratio of the normalized current to the normalized flow rate, and by using the current magnification, it is possible to eliminate the influence of the flow rate on the boron removal efficiency. The boron removal efficiency improves as the current magnification increases. For example, when the boron concentration of the supplied water is 10 ppb, increasing the current magnification by about 1.2 times reduces the boron concentration to 50 ppt or less (removal efficiency of 99.5% or more). However, improving the boron removal efficiency becomes difficult as the current magnification increases, and in order to reduce the boron concentration to 20 ppt or less (removal efficiency of 99.8%), it is necessary to increase the number of stages or improve the performance of electrodeionization device 18. As can be understood from the above, it is necessary to decide which of the first operation and the second operation should be given priority while taking into consideration the operating cost and equipment cost required for boron removal efficiency.

### Fifth Embodiment

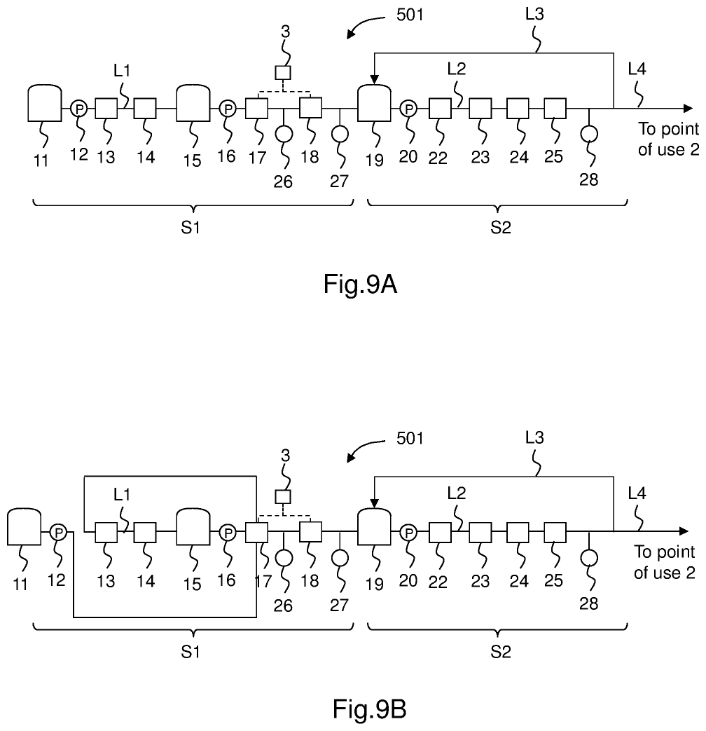

FIG. 9A shows a schematic configuration of a water treatment system 501 according to the fifth embodiment of the present invention. This embodiment is similar to the fourth embodiment except that secondary system S2 is not provided with heat exchanger 21 or other water temperature adjusting means. As described above, the temperature adjustment of the water supplied to electrodeionization device 18 and the temperature adjustment of point of use 2 are performed by cooler 17. The water temperature adjustment means refers to devices for the purpose of adjusting water temperature, such as heat exchangers and heaters, but does not include devices such as pumps that may cause changes in water temperature during operation but whose purpose is not to adjust water temperature. Since secondary system S2 is not provided with a water temperature adjustment means, the difference T1−T2 is affected only by the exhaust heat of the component equipment, the circulating flow rate, and the ambient temperature, and the difference T1−T2 is within the range of from −1.0 degrees or more to 1.0 degrees or less. Therefore, this embodiment is preferably applied when the temperature of the water supplied to electrodeionization device 18 is close to the water temperature required by point of use 2. Since the required water temperature at point of use 2 is often around 24° C. to 26° C., the temperature of the water supplied to electrodeionization device 18 is also around that range. This embodiment is suitable for cases in which sufficient boron removal performance is obtained at a water temperature near the required water temperature of point of use 2, in which boron removal is mainly performed in the second operation described above, or in which operation is performed in combination with the second operation.

FIG. 9B shows a modification of the fifth embodiment. In this embodiment, as in the first embodiment, raw water tank 11, raw water pump 12, cooler 17, temperature adjustment device 13, at least one reverse osmosis membrane device 14, and at least one electrodeionization (EDI) device 18 are arranged in series, and the water being treated again passes through cooler 17 between reverse osmosis membrane device 14 and electrodeionization device 18. That is, temperature adjustment device 13 corresponds to first heat exchanger 31 of the first embodiment, and cooler 17 corresponds to second heat exchanger 32 of the first embodiment.

### Sixth Embodiment

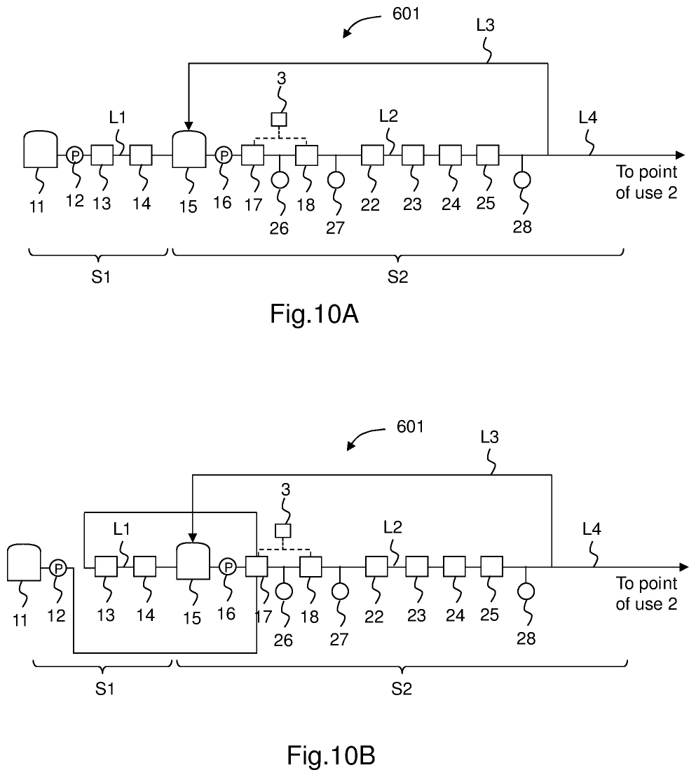

FIG. 10A shows a schematic configuration of water treatment system 601 according to the sixth embodiment of the present invention. In this embodiment, electrodeionization device 18 is provided in secondary system S2. In this embodiment as well, the temperature adjustment of the water supplied to electrodeionization device 18 and the temperature adjustment of point of use 2 are performed by cooler 17. In this embodiment, pure water tank 19 and pure water pump 20 are omitted, and second recirculation line L3 is connected to RO treated water tank 15. Therefore, in this embodiment, the water being treated is always treated by electrodeionization device 18 when circulating through secondary system S2. Since secondary system S2 is not provided with heat exchanger 21 or other water temperature adjustment means, the difference T1−T2 is within the range of from −1.0 degrees or more to 1.0 degrees or less. This embodiment can also be suitably applied under the same conditions as the second embodiment.

FIG. 10B shows a modification of the sixth embodiment. In this embodiment, as in the first embodiment, raw water tank 11, raw water pump 12, cooler 17, temperature adjustment device 13, at least one reverse osmosis membrane device 14, and at least one electrodeionization (EDI) device 18 are arranged in series, and the water being treated again passes through cooler 17 between reverse osmosis membrane device 14 and electrodeionization device 18. That is, temperature adjustment device 13 corresponds to first heat exchanger 31 of the first embodiment, and cooler 17 corresponds to second heat exchanger 32 of the first embodiment.

### Seventh Embodiment

As mentioned above, the preferred temperature of the water supplied to reverse osmosis membrane device 14 is generally higher than the preferred temperature of the water supplied to electrodeionization device 18. The water temperature at point of use 2 is required to be maintained within a certain range but is usually higher than the preferred temperature of the water supplied to electrodeionization device 18. Therefore, the water to be treated is generally heated at the inlet of reverse osmosis membrane device 14, cooled at the inlet of electrodeionization device 18, and heated again in secondary system S2. However, conventionally, water being treated is heated, cooled, and heated again using mutually independent heat exchangers, and each of these steps consumes energy. In the seventh to ninth embodiments, the waste heat of the treated water of reverse osmosis membrane device 14 is used to heat the water supplied to reverse osmosis membrane device 14 and/or to heat the treated water of electrodeionization device 18, and the energy usage efficiency of the entire ultrapure water production apparatuses 1D to 1F is thus improved.

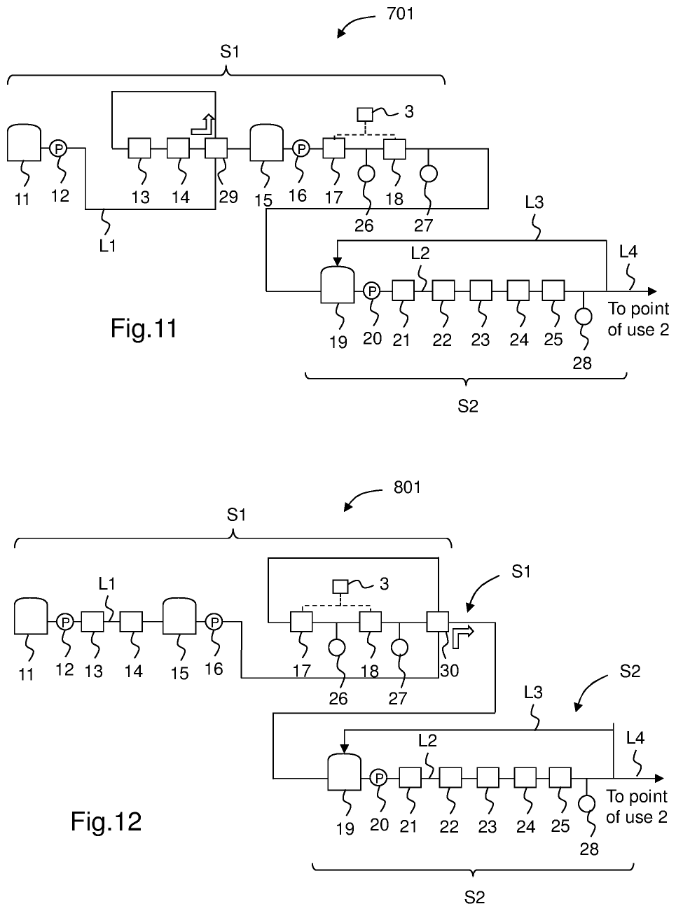

FIG. 11 shows a schematic configuration of water treatment system 701 according to the seventh embodiment of the present invention. In this embodiment, as in the fourth to sixth embodiments, reverse osmosis membrane device 14 is provided upstream of electrodeionization device 18, and temperature adjustment device 13 is provided upstream of reverse osmosis membrane device 14. In this embodiment as well, temperature adjustment device 13 adjusts the temperature of the water supplied to reverse osmosis membrane device 14 to 15° C. or higher and 40° C. or lower, and preferably from about 20° C. to 30° C. When the water temperature measured by first thermometer 28 at the installation position of first thermometer 28 exceeds the value corresponding to the required water temperature of point of use 2, cooler 17 is activated. In addition, this embodiment is provided with fifth heat exchanger 29 that recovers heat from the treated water of reverse osmosis membrane device 14 and heats the water supplied to reverse osmosis membrane device 14. Arrows indicate the direction of heat transfer. The water supplied to reverse osmosis membrane device 14 is heated in fifth heat exchanger 29 before being heated in temperature adjustment device 13. Therefore, the thermal energy required by temperature adjustment device 13 is saved. On the other hand, the treated water of reverse osmosis membrane device 14 is cooled by cooler 17 after transmitting thermal energy to the water supplied to reverse osmosis membrane device 14. Therefore, the temperature of treated water supplied to cooler 17 decreases, and the cooling load on cooler 17 decreases. In this embodiment, thermal energy is transferred from water that does not require thermal energy to water that requires thermal energy by heat exchange, with the result that the energy usage efficiency of ultrapure water production apparatus 1D is improved. Fifth heat exchanger 29 corresponds to first heat exchanger 31 of the first to third embodiments.

### Eighth Embodiment

FIG. 12 shows a schematic configuration of water treatment system 801 according to the eighth embodiment of the present invention. In this embodiment, as in the fourth to sixth embodiments, reverse osmosis membrane device 14 is provided upstream of electrodeionization device 18, and temperature adjustment device 13 is provided upstream of reverse osmosis membrane device 14. In this embodiment as well, temperature adjustment device 13 adjusts the temperature of the water supplied to reverse osmosis membrane device 14 to 15° C. or higher and to 40° C. or lower, and preferably to about 20° C. to 30° C. When the water temperature measured by first thermometer 28 at the installation position of first thermometer 28 exceeds the value corresponding to the required water temperature of point of use 2, cooler 17 is activated. In addition to this, the present embodiment includes sixth heat exchanger 30 that recovers heat from the treated water of reverse osmosis membrane device 14 to heat the treated water of electrodeionization device 18. The treated water of electrodeionization device 18 is heated in sixth heat exchanger 30 and then further heated in heat exchanger 21. Therefore, the thermal energy required by heat exchanger 21 is saved. In a modification, heat exchanger 21 can also be omitted. Similar to the fourth embodiment, the treated water of reverse osmosis membrane device 14 is cooled by cooler 17 after transmitting thermal energy to the water supplied to reverse osmosis membrane device 14. Therefore, the temperature of the treated water supplied to cooler 17 decreases, and the cooling load on cooler 17 also decreases. In this embodiment as well, the energy usage efficiency of water treatment system 801 is improved because thermal energy is transferred by heat exchange from a portion that does not require thermal energy to a portion that requires thermal energy. Further, as described above, temperature adjustment device 13 can be a heater, a cooler, or a temperature controller depending on the temperature of the water supplied to reverse osmosis membrane device 14 and can be omitted. Sixth heat exchanger 30 corresponds to second heat exchanger 32 of the first to third embodiments.

### Ninth Embodiment

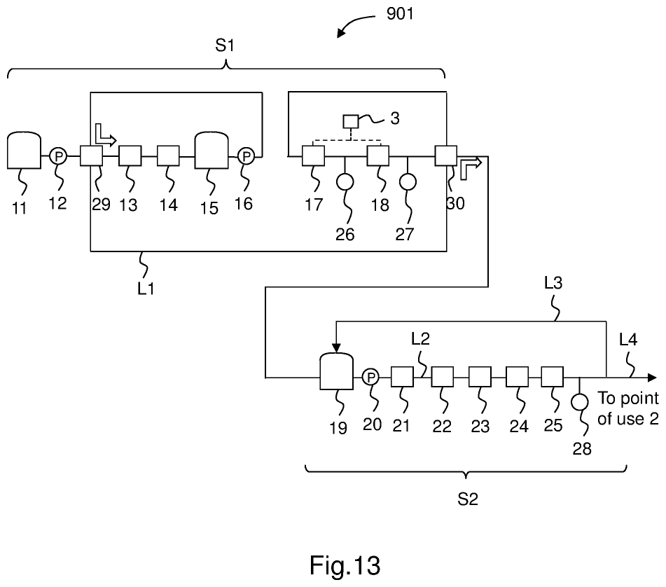

FIG. 13 shows a schematic configuration of water treatment system 901 according to the ninth embodiment of the present invention. This embodiment is a combination of the seventh embodiment and the eighth embodiment. Water treatment system 901 of this embodiment comprises fifth heat exchanger 29 that recovers heat from the treated water of reverse osmosis membrane device 14 and heats the water supplied to reverse osmosis membrane device 14, and sixth heat exchanger 30 that recovers heat from the treated water of electrodeionization device 18 and heats the treated water of electrodeionization device 18. First heat exchanger 29 may be a heater that recovers heat from the supplied water (raw water) and heats the transmitted water of reverse osmosis membrane device 14. After the heat of the treated water of reverse osmosis membrane device 14 is recovered by first heat exchanger 29, the heat is further recovered by heat exchanger 30. This embodiment can have the effects of the fourth embodiment and the fifth embodiment at the same time. That is, the thermal energy required by temperature adjustment device 13 and heat exchanger 21 is saved, and the cooling load on cooler 17 is reduced, with the result that the energy usage efficiency of water treatment system 901 is further improved.

While several preferred embodiments of the invention have been shown and described in detail, it will be understood that various changes and modifications can be made without departing from the spirit or scope of the appended claims.

### REFERENCE NUMBER LIST

2: point of use
3: control device
13: temperature adjustment device
14: reverse osmosis membrane device
15: RO treated water tank
17: cooler
18: electrodeionization device
26: second thermometer
27: boron concentration measuring device
28: first thermometer
29: fifth heat exchanger
30: sixth heat exchanger
31: first heat exchanger
32: second heat exchanger
33: third heat exchanger
34: fourth heat exchanger
101, 201, 301, 401, 501, 501, 701,801,901: water treatment system
L3: second recirculation line
L5: first recirculation line
S1: primary system
S2: secondary system (subsystem)

1. A water treatment system comprising at least one reverse osmosis membrane device and at least one electrodeionization device that is located downstream of the at least one reverse osmosis membrane device, the system comprising:
a first heat exchanger that is located upstream of the at least one reverse osmosis membrane device and that adjusts the temperature of the water supplied to the at least one reverse osmosis membrane device according to the temperature of a raw water supplied to the water treatment system; and
a second heat exchanger that is located between the at least one reverse osmosis membrane device and the at least one electrodeionization device and that cools the water supplied to the electrodeionization device,
wherein one of the first heat exchanger and the second heat exchanger is an internal heat exchanger that exchanges heat inside the water treatment system, and the other is an external heat exchanger that exchanges heat with outside of the water treatment system.

2. The water treatment system according to claim 1, wherein:
the temperature of the raw water is lower than the temperature of the water treated by the reverse osmosis membrane device; and
the first heat exchanger is the external heat exchanger, the second heat exchanger is the internal heat exchanger, and the first heat exchanger operates as a heater.

3. The water treatment system according to claim 1, wherein:
the temperature of the raw water is higher than the temperature of the treated water of the electrodeionization device; and
the first heat exchanger is the internal heat exchanger, the second heat exchanger is the external heat exchanger, and the second heat exchanger operates as a cooler.

4. The water treatment system according to claim 3, further comprising a third heat exchanger that is located between the first heat exchanger and the reverse osmosis membrane device and that cools the water supplied to the reverse osmosis membrane device.

5. The water treatment system according to claim 1, further comprising a fourth heat exchanger that is located between the second heat exchanger and the electrodeionization device and that cools the water supplied to the electrodeionization device, wherein:
the first heat exchanger is the external heat exchanger, the second heat exchanger is the internal heat exchanger, and the external heat exchanger operates as a heater or a cooler.

6. The water treatment system according to claim 1, further comprising a subsystem located between the electrodeionization device and a point of use, wherein:
the subsystem includes a water treatment device that further treats the treated water of the electrodeionization device, and a second recirculation line that returns the treated water of the water treatment device to upstream of the water treatment device.

7. The water treatment system according to claim 1, wherein:
the temperature of the water supplied to the reverse osmosis membrane device is controlled within a range of from 15° C. or higher to 40° C. or lower.

8. The water treatment system according to claim 1, wherein:
the temperature of the water supplied to the electrodeionization device is controlled within a range of from 10° C. or higher to 30° C. or lower.

9. The water treatment system according to claim 1, wherein:
the raw water contains silica and boron, the silica concentration of the water treated by the reverse osmosis membrane device is 100 ppb or less, and the boron concentration is 50 ppb or less.

10. A water treatment method in a water treatment system comprising at least one reverse osmosis membrane device and at least one electrodeionization device located downstream of the at least one reverse osmosis membrane device, the method comprising:
adjusting the temperature of the water supplied to the at least one reverse osmosis membrane device according to the temperature of the raw water supplied to the water treatment system by a first heat exchanger located upstream of the reverse osmosis membrane device; and
cooling the water supplied to the electrodeionization device by a second heat exchanger located between the reverse osmosis membrane device and the electrodeionization device,
wherein one of the first heat exchanger and the second heat exchanger is an internal heat exchanger that exchanges heat inside the water treatment system, and the other is an external heat exchanger that exchanges heat with outside of the water treatment system.

11. The water treatment system according to claim 1, further comprising: a primary system; a subsystem located downstream of the primary system and upstream of the point of use; and a first thermometer that measures the temperature of water that is treated by the electrodeionization device and that flows downstream of the electrodeionization device, wherein:
the second heat exchanger is a cooler that cools the water supplied to the electrodeionization device; and
the cooler is activated when the water temperature measured by the first thermometer exceeds a value at the installation position of the first thermometer that corresponds to a required water temperature of the point of use.

12. The water treatment system according to claim 11, wherein the first thermometer measures the temperature of treated water of one of the water treatment devices constituting the subsystem.

13. The water treatment system according to claim 12, further comprising a second thermometer that measures the temperature of water either entering or exiting the electrodeionization device, wherein:
the cooler operates so that difference T1−T2 between the temperature T1 measured by the first thermometer and the temperature T2 measured by the second thermometer is −1 degrees or more and 5 degrees or less.

14. The water treatment system according to claim 13, wherein:
the electrodeionization device is provided in the primary system;
the difference T1−T2 is −1.0 degrees or more and 1.0 degrees or less; and
the subsystem is not provided with water temperature adjustment means.

15. The water treatment system according to claim 13, wherein:
the electrodeionization device is provided in the subsystem;
the difference T1−T2 is −1.0 degrees or more and 1.0 degrees or less; and
the subsystem is not provided with water temperature adjustment means other than the cooler.

16. The water treatment system according to claim 11, further comprising a temperature adjustment device that is provided upstream of the at least one reverse osmosis membrane device, wherein:
the temperature adjustment device adjusts the temperature of the water supplied to the reverse osmosis membrane device to 15° C. or higher and 40° C. or lower.

17. The water treatment system according to claim 16, wherein:
the first heat exchanger recovers heat from the treated water of the at least one reverse osmosis membrane device and heats or cools the water supplied to the reverse osmosis membrane device.

18. The water treatment system according to claim 16, wherein:
the second heat exchanger recovers heat from the treated water of the at least one reverse osmosis membrane device and heats the treated water of the electrodeionization device.

19. The water treatment system according to claim 11, further comprising a boron concentration measuring device for measuring the boron concentration of the treated water of the electrodeionization device, and a control device, wherein:
the cooler is capable of a first operation that cools water supplied to the electrodeionization device;
the electrodeionization device is capable of a second operation in which the applied current is increased; and
the control device controls the cooler and the electrodeionization device so that only one of the first operation and the second operation is performed when the boron concentration measured by the boron concentration measuring device is higher than a predetermined value.

20. The water treatment system according to claim 19, wherein:
the control device controls the cooler and the electrodeionization device so that when the boron concentration does not become equal to or less than the predetermined value by only one of the first operation and the second operation, the other of the first operation and the second operation is performed.
